(19) United States
(12) Patent Application Publication
(10) Pub. No.: US 2012/0086749 A1
(43) Pub. Date: Apr. 12, 2012

(54) PRINTING DEVICE

(75) Inventor: Toyohiko MITSUZAWA, Shiojiri-shi (JP)

(73) Assignee: SEIKO EPSON CORPORATION, Tokyo (JP)

(21) Appl. No.: 13/242,360

(22) Filed: Sep. 23, 2011

(30) Foreign Application Priority Data
Oct. 6, 2010 (JP) 2010-226387

(51) Int. Cl. B41J 29/38

(52) U.S. Cl. 347/14

(57) ABSTRACT

A printing device includes: a lighting unit that irradiates ink droplets landing on a surface of a printing medium with activated light rays to harden the ink droplets; a transport unit that transports at least one of the printing medium and the lighting unit to move the ink droplets on the surface of the printing medium to an irradiation range of the activated light rays irradiated by the lighting unit; and a plurality of nozzles that ejects various kinds of ink droplets with different ink amounts, and are arranged such that distances of the nozzles from the lighting in a direction parallel to a transport direction of the transport unit are different from each other.

### BACKGROUND

1. Technical Field

The entire disclosure of Japanese Patent Application No. 2010-226387, filed Oct. 6, 2010 is expressly incorporated by reference herein.

The present invention relates to a printing device which performs printing using ink droplets hardened by activated light rays.

2. Related Art

In the related art, an ink jet printing device is known in which ink droplets after landing on a recording medium are irradiated with activated light rays to harden the ink droplets. The ink droplets are prevented from spreading by hardening the landed ink droplets. As a result, it is possible to prevent image quality from decreasing. In JP-A-2003-191594, it is described that the irradiation conditions of the activated light rays are changed. For example, irradiation period, irradiation timing, irradiation intensity, irradiation energy, kind of irradiation light source, irradiation area, incident angle of activated light rays to recording material face, and wavelength characteristics of irradiated activated light rays are described as the irradiation conditions. In JP-A-2007-245732, a printing device having a full line type ink jet head is described in which a light emission range or a light emission intensity are changed according to the width of a recording medium, the area of ink ejected to a printing medium, reflective index, and the like.

After ink droplets are ejected from nozzles to a printing medium, as the time until the ink droplets are irradiated with activated light rays lengthens, the ink droplets spread further on the surface of the printing medium. That is, the diameter (diameter on a face parallel to the surface of the printing medium) of the ink droplets gets larger, the height of the ink droplets (a distance between the surface of the printing medium and the top of the ink droplets) gets lower, and thus the surface area increases. As the surface area of the ink droplets gets larger, the ratio of a volume of a surface layer portion of the ink droplets affected by oxygen obstruction (the state where hardening is obstructed by oxygen) to the whole volume of the ink droplets increases. Even when the ink droplets are irradiated with the activated light rays in that state, the surface layer portion of the ink droplets is not hardened. Accordingly, a ratio of the volume of the non-hardened portion to the whole volume of the ink droplets is high, which is “unsatisfactory hardening”. A ratio (S_{S}/V_{S}) of a surface area (S_{S}) to a volume (V_{S}) of a small ink droplet in which a volume per droplet is small is higher than the ratio (S_{L}/V_{L}) of the surface area (S_{L}) to the volume (V_{L}) of a large ink droplet in which the volume per droplet is larger than that of the small ink droplet. For this reason, the small ink droplets more easily are unsatisfactorily hardened than the larger ink droplets.

For example, even in a case of small ink droplets which are unsatisfactorily hardened in activated light rays with a given energy, it is possible to harden the ink droplets by irradiating the ink droplets with activated light rays a higher energy. Although it is possible to prevent any ink droplet from being the unsatisfactory hardening using activated light rays with high energy which do not cause the unsatisfactory hardening even in any of large, medium, and small ink droplets, it is preferable to harden the ink droplets using activated light rays with energy as low as possible from the viewpoint of costs. For this reason, it is more preferable to change the irradiation energy according to the size of the ink droplet. However, in a printing device in which ink droplets with various sizes can be ejected, it is difficult to change the irradiation situation according to the sizes of the ejected ink droplets.

### SUMMARY

An advantage of some aspects of the invention is to prevent unsatisfactory hardening of ink droplets after landing from easily occurring without changing an irradiation situation of activated light rays.

According to a printing device, in nozzles ejecting ink droplets in which a pre-irradiation time until the ink droplets move to an irradiation range of an irradiation unit after the ink droplets land on a printing medium is a second pre-irradiation time longer than a first pre-irradiation time, a configuration of lowering ejection probability of small ink droplets lower than that of nozzles ejecting ink droplets in which a pre-irradiation time is the first pre-irradiation time is employed. When the pre-irradiation time gets longer, the surface area of the ink droplets on the surface of the printing medium gets larger, and thus the ink droplets are easily affected by an influence of oxygen obstruction. In addition, the small ink droplets are more easily affected by the influence of oxygen obstruction as compared with the ink droplets with a volume larger than that of the small ink droplets. Accordingly, in the configuration of the invention, it is possible to prevent the unsatisfactory hardening in the small ink droplets landing on the printing medium from easily occurring, as compared with the configuration of ejecting the small ink droplets at the same probability in a plurality of nozzles in which lengths of pre-irradiation times are different.

In recording pixels constituting an image formed on the printing medium, the ejection of ejected ink droplets or the size (dot size) of the ink droplets in case of ejection may be determined by a halftone process using, for example, a dither method or an error diffusion method, on the basis of ink amount gradation values of the recording pixels. When the ink droplets are ejected to the recording pixels, the nozzles ejecting the ink droplets to the recording pixels may be specified if the resolution or another printing condition is determined. Accordingly, a halftone process is performed such that probability of selecting small dots in the recording pixels assignable to the nozzles in which the pre-irradiation time is the second pre-irradiation time is lower than probability of selecting small dots in the recording pixels assignable to the nozzles in which the pre-irradiation time is the first pre-irradiation time, thereby changing the ejection probability of the small ink droplets in the nozzles in which the irradiation times are different. The ejection probability of small ink droplets in nozzles means probability that one dot (small dot) of one recording pixel is formed by only small ink droplets ejected from the nozzles. That is, it means probability that small dots are selected by the halftone process in the recording pixels assignable to the nozzles. Accordingly, for example, the number of cases of ejecting two or more small ink droplets to form dots larger than small dots in the recording pixel does not contribute to the ejection probability of the small ink droplets.

The lighting unit may preferably irradiate the ink droplets landing on the surface of the printing medium with activated light rays for hardening the ink droplets. In addition, in the specification, the activated light rays are irradiated in the same condition in various irradiation conditions as long as it is not particularly described such as the irradiation time, the irradiation timing, the irradiation intensity, the irradiation energy, the kind of light source, the irradiation area, the incident angle to the recording medium, and the wavelength characteristic.

Preferably, the transport unit may relatively change a positional relationship between the lighting unit and the printing medium such that the ink droplets ejected from the nozzles and landing on the surface of the printing medium fall within the irradiation range of the activated light rays irradiated by the lighting unit. That is, the transport unit may have a configuration of transporting the printing medium toward the irradiation range, may have a configuration of transmitting the lighting unit to the printing medium, and may have a configuration of transporting both.

The plurality of nozzles provided in the printing device according to the aspect of the invention are disposed such that distances thereof from the lighting unit in the direction parallel to the transport direction of the transport unit are different from each other. That is, the pre-irradiation time of the ink droplets ejected from the nozzles far away from the lighting unit and landing on the printing medium is longer than that of the ink droplets ejected from the close nozzles and landing on the printing medium. The nozzles provided in the printing device according to the aspect of the invention may eject small ink droplets, and ink droplets with a greater amount of ink than the small ink droplets.

In the invention, the small ink droplets may not be ejected from the nozzles ejecting the ink droplets in which the pre-irradiation time is larger than a predetermined threshold value. As for the small ink droplets, the threshold value is a time from landing to irradiation, and is set on the basis of the time when it is not in a state defined as unsatisfactory hardening by oxygen obstruction even when the irradiation is performed at the time point when the time is elapsed. For example, the longest time when it is not in the state (the time when it is the state if the time is longer than that) is set. Accordingly, since the small ink droplets are not ejected from the nozzles in which the pre-irradiation time is larger than the threshold value, it is possible to prevent the unsatisfactory hardening caused by the oxygen obstruction of the small ink droplets from occurring. In addition, since the activated light rays are irradiated in the same lighting conditions (irradiation timing and the like) in the lighting unit as described above, the pre-irradiation time is not changed by the influence of the irradiation timing of the lighting unit.

The nozzles in which distances thereof from the lighting unit in the direction parallel to the transport direction are longer than a predetermined distance may be the nozzles ejecting the ink droplets in which the pre-irradiation time is larger than the threshold value described above. When the transport velocity of the transport unit is constant, the distance between the nozzle ejecting any ink droplet and the lighting unit is proportional to the pre-irradiation time of the ink droplet, and thus it is possible to set a predetermined distance from the threshold value and the transport velocity described above. It may be determined whether the nozzles are to eject the small ink droplets by comparing the distance between the lighting unit and the nozzles in the transport direction with a predetermined distance. In addition, the threshold value represented by time may be considered as constant if the other conditions (e.g., temperature, kind of ink, and the like) related to the ease of spreading of ink droplets including kinds of printing mediums to be described later are the same. Accordingly, as the transport velocity in the transport unit increases, the predetermined distance is set to a longer distance. Since the activated light rays are irradiated in the same lighting conditions (irradiation angle and the like) in the light unit as described above, it may be described in other words such as “the small ink droplets are not ejected from the nozzles in which the distance from the irradiation of the lighting unit in the transport direction is longer than a predetermined distance”.

In the invention, when using the second printing medium on which the ink droplets after landing spread more easily than the first printing medium, the threshold value of the pre-irradiation time may be smaller than that of the case of using the first printing medium. Since the surface area of the ink droplets increases at a high velocity as the ink droplets more easily spread on the printing medium, the ink droplets become easily the unsatisfactory hardening by oxygen obstruction. For this reason, even in the configuration in which the set value of the threshold value can be changed according to the printing medium on which the ease of spreading of the ink droplets is different, it is possible to prevent the unsatisfactory hardening of the ink droplets even in various printing mediums from occurring.

In the invention, the nozzles ejecting the ink droplets with an ink color in which the small ink droplets are easily ejected may be disposed at positions close to the lighting unit in the direction parallel to the transport direction. Since the nozzles with the ink color in which the small ink droplets are easily ejected are disposed at the positions closer to the lighting unit than the nozzles with an ink color in which the small ink droplets are not easily ejected, the pre-irradiation time of the ink droplets ejected from the nozzles in which the small ink droplets are easily ejected can be made shorter than the pre-irradiation time of the ink droplets ejected from the nozzles in which the small ink droplets are not easily ejected. As a result, it is easy to prevent the unsatisfactory hardening of the small ink droplets with the ink color in which the small ink droplets are easily ejected, and it is possible to improve image quality of the ink color in which the small ink droplets are easily ejected. The ink color in which the small ink droplets are easily ejected means an ink color in which formation of a small dot is easily selected by a halftone process. More specifically, it is an ink color used to express a faint color, and is an ink color causing a granularity feeling when it is represented by a dot larger than the small dot.

The printing device according to the aspect of the invention is not limited to realization as a single device, and units of the printing device according to the aspect of the invention may correspond to a plurality of devices. For example, the printing device according to the aspect of the invention may be realized by a computer executing a printer driver and a printer. The functions of the units described in the aspects are realized by a hardware resource in which a function is specified by the configuration itself, a hardware resource in which a function is specified by a program, or combination thereof. The functions of the units are not limited to realization based on hardware resources which are physically independent from each other. The invention may be a recording medium of a printing program. Of course, the recording medium of the computer program may be a magnetic recording medium, a magneto-optical recording medium, and any recording medium which will be developed in the further.

### BRIEF DESCRIPTION OF THE DRAWINGS

The invention will be described with reference to the accompanying drawings, wherein like numbers reference like elements.

FIG. 1A is a block diagram illustrating a printing device, and FIG. 1B is a bottom view illustrating a printing head.

FIG. 2A is a graph illustrating a relationship between a height of an ink droplet and an elapsed time, and FIG. 2B is a schematic diagram illustrating change in shape of an ink droplet.

FIG. 3A and FIG. 3B are diagrams illustrating a relationship between nozzles and a lighting unit.

FIG. 4 is a schematic diagram illustrating an image process in a printing control process.

FIG. 5 is a flowchart illustrating a halftone process.

FIG. 6A and FIG. 6B are graphs illustrating a correspondence relationship between an ink amount gradation and a dot forming probability.

FIG. 7 is a diagram illustrating a printing head according to a modified example.

### DESCRIPTION OF EXEMPLARY EMBODIMENTS

Hereinafter, embodiments of the invention will be described in the following order with reference to the accompanying drawings. The same reference numerals and signs are given to the corresponding constituent elements in the drawings, and the repeated description is omitted.
(1) Configuration of Printing Device
(2) Change of Shape of Ink Droplet
(3) Printing Control Process
(4) Modified Example

### (1) CONFIGURATION OF PRINTING DEVICE

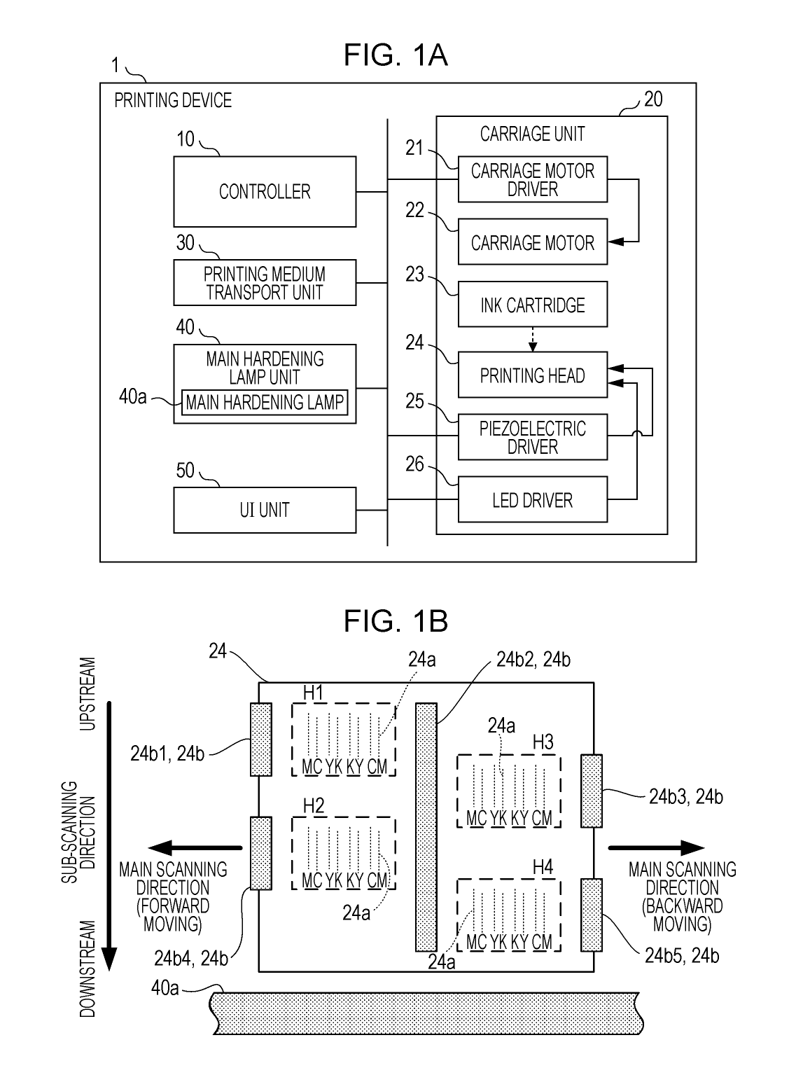

FIG. 1A is a block diagram illustrating a printing device 1 according to an embodiment of the invention. The printing device 1 is a serial ink jet printer which forms a printing image on a recording medium by an ultraviolet curing type ink. The printing device 1 includes a controller 10, a carriage unit 20, a printing medium transport unit 30, a main hardening lamp unit 40, and a UI (User Interface) unit 50. The controller 10 includes an ASIC, a CPU, a ROM, and a RAM, which are not shown. The CPU executing programs recorded in the ASIC and ROM performs various calculation processes for a printing control process to be described later. The printing control process is a process of controlling the carriage unit 20, the printing medium transport unit 30, the main hardening lamp unit 40, and the like to form a printing image on the recording medium.

The carriage unit 20 includes a carriage motor 22, a carriage motor driver 21, an ink cartridge 23, a printing head 24, a piezoelectric driver 25, and an LED driver 26. The carriage motor 22 generates power for driving the printing head 24 in a main scanning direction. The carriage motor drive 21 generates a driving signal necessary to drive the carriage motor 22 on the basis of a control signal from the controller 10. In the embodiment, the carriage motor 22 and the carriage motor driver 21 correspond to a transport unit. The ink cartridge 23 stores ink to be supplied to the printing head 24. The ink cartridge 23 of the embodiment stores ink of C (cyan), M (magenta), Y (yellow), and K (black). The ink is an ultraviolet curing ink, and includes an ultraviolet polymerizing resin polymerized by receiving ultraviolet energy, a polymerization initiator, a color material, and the like.

FIG. 1B is a bottom view as viewing the printing head 24 from the recording medium side. The printing head 24 has a nozzle face opposed to the recording medium, and is provided with a plurality of nozzles 24a arranged on the nozzle face. The nozzles 24a communicate with an ink chamber (not shown), and the ink chamber is filled with the ink supplied from the ink cartridge 23. The ink chamber is provided with a piezoelectric element (not shown) for each nozzle 24a, and the piezoelectric driver 25 applies a driving voltage pulse to the piezoelectric element on the basis of the control signal from the controller 10. When the driving voltage pulse is applied to the piezoelectric element, the piezoelectric element is mechanically deformed to pressurize and depressurize the ink in the ink chamber. Accordingly, the ink droplets are ejected from the nozzles 24a to the recording medium. The pressurized and depressurized state of the ink in the ink chamber is adjusted by the pulse shape of the driving voltage pulse, and thus it is possible to adjust the size of the ink droplets ejected from the nozzles 24a.

Four rectangular head areas H1 to H4 are provided on the nozzle face of the printing head 24, nozzle rows corresponding to the inks of CMYK and extending in the sub-scanning direction are disposed in total 8 rows of each 2 rows in the head areas H1 to H4. The nozzle rows of the same ink color in the head areas H1 to H4 are disposed to be bilateral symmetric in the main scanning direction. In the embodiment, the nozzle rows are disposed in order of M, C, Y, and K from the outside in the head areas H1 to H4. The nozzles 24a belonging to each nozzle row are disposed at a regular space period in the sub-scanning direction, and the space period is 1/360 inch. The nozzles 24a belonging to the adjacent nozzle row are disposed at a position deviating by 1/720 inch in the sub-scanning direction.

In the embodiment, the piezoelectric driver 25 generates a driving voltage pulse for forming dots with 3 kinds of dots with different sizes on the recording medium, and applies the driving voltage pulse to the piezoelectric element. That is, the piezoelectric driver 25 generates 3 kinds of driving voltage pulses for forming a large dot, a medium dot, and a small dot on the recording medium. The ink droplets for forming the large dot on the surface of the printing medium are called large ink droplets. Similarly, the ink droplets forming the medium dot are called medium ink droplets, and the ink droplets forming the small dot are called small ink droplets. A largeness and smallness relationship of the amount (weights) of ink corresponding to ink droplets for forming each dot is large ink droplets>medium ink droplets>small ink droplets.

The printing head 24 is provided with preliminary hardening LED 24b (24b1, 24b2, 24b3, 24b4, and 24b5) emitting ultraviolet light from the nozzle face to the recording medium. The preliminary hardening LED 24b emits ultraviolet light as activated light rays by the driving current generated by the LED on the basis of the control signal from the controller 10. The ink droplets landing on the recording medium are hardened by the ultraviolet light emitted by the preliminary hardening LED 24b. That is, polymerization in the ink droplets landing on the recording medium starts proceeding by the energy of the ultraviolet light emitted by the preliminary hardening LED 24b.

In the embodiment, the preliminary hardening LEDs 24b1 and 24b4 is provided on one short side in the main scanning direction of the printing head 24, the preliminary hardening LEDs 24b3 and 24b5 is provided on the other short side, and the preliminary hardening LED 24b2 is provided at the center in the main scanning direction of the printing head 24. The nozzles 24a in the head area H1 are pinched in the main scanning direction by the preliminary hardening LEDs 24b1 and 24b2. The nozzles 24a in the head area H2 are pinched in the main scanning direction by the preliminary hardening LEDs 24b4 and 24b2. The nozzles 24a in the head area H3 are pinched in the same manner by the preliminary hardening LEDs 24b2 and 24b3. The nozzles 24a in the head area H4 are pinched in the same manner by the preliminary hardening LEDs 24b2 and 24b5. Accordingly, even when the printing head 24 is scanned in any direction, it is possible to irradiate the ink droplets just after landing with the ultraviolet light from the preliminary hardening LED 24b.

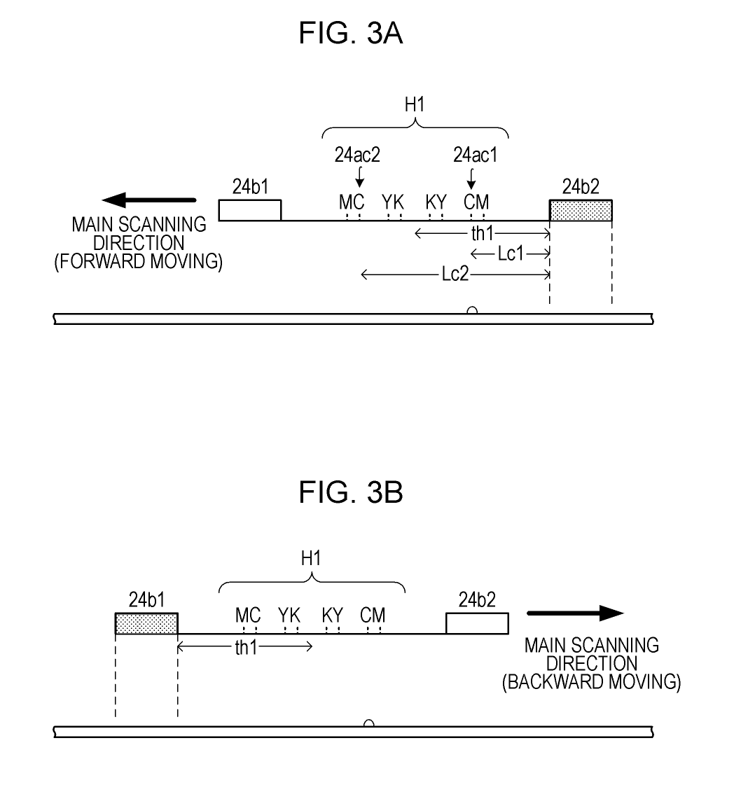

In addition, at the time of forward movement in forward and backward movement of the printing head 24 in the main scanning direction, the preliminary hardening LED 24b positioned on the upstream side of the forward movement with respect to the nozzles 24a of the head areas H1 to H4 corresponds to the lighting unit. At the time of backward movement of the printing head 24, the preliminary hardening LED 24b on the upstream side of the backward movement with respect to the nozzles 24a of the head areas H1 to H4 corresponds to the lighting unit. FIGS. 3A and 3B show a positional relationship of the preliminary hardening LEDs 24b1 and 24b2 and the nozzles 24a of the head area H1 viewed from the sub-scanning direction. For example, when paying attention to the nozzles of the head area H1, the preliminary hardening LED 24b2 corresponds to the lighting unit as shown in FIG. 3A at the time of forward movement, and the preliminary hardening LED 24b1 corresponds to the lighting unit as shown in FIG. 3B at the time of backward movement.

The printing medium transport unit 30 includes a transport motor, a transport roller, and a motor driver, which are not shown, and transports the recording medium in the sub-scanning direction perpendicular to the main scanning direction on the basis of the control signal from the controller 10. Accordingly, it is possible to relatively move the printing head 24 and the recording medium in the main scanning direction and the sub-scanning direction, and it is possible to form a 2-dimensional printing image by causing the ink droplets to land at positions of the recording medium.

The main hardening lamp unit 40 has a main hardening lamp 40a further to the downstream side to the printing head 24 in the transport direction of the recording medium. The main hardening lamp 40a is provided with, for example, a metal halide lamp or a mercury lamp or an LED lamp, and emits ultraviolet light with energy higher than that of the preliminary hardening LED 24b by the driving current supplied by a driver (not shown) on the basis of the control signal from the controller 10. The polymerization in the ink droplets landing on the recording medium further proceeds by the energy of the ultraviolet light emitted by the main hardening lamp 40a, and the ink droplets are hardened.

The UI unit 50 is provided with a display unit displaying an image and an operation unit receiving an operation. The UI unit 50 displays a printing setting image for receiving the settings of various printing conditions including the recording medium for performing the printing, on the display unit on the basis of the control signal from the controller 10. The UI unit 50 receives the settings of the printing conditions such as the printing medium by the operation unit, and outputs the operation signal representing the setting contents to the controller 10.

### (2) CHANGE OF SHAPE OF INK DROPLET

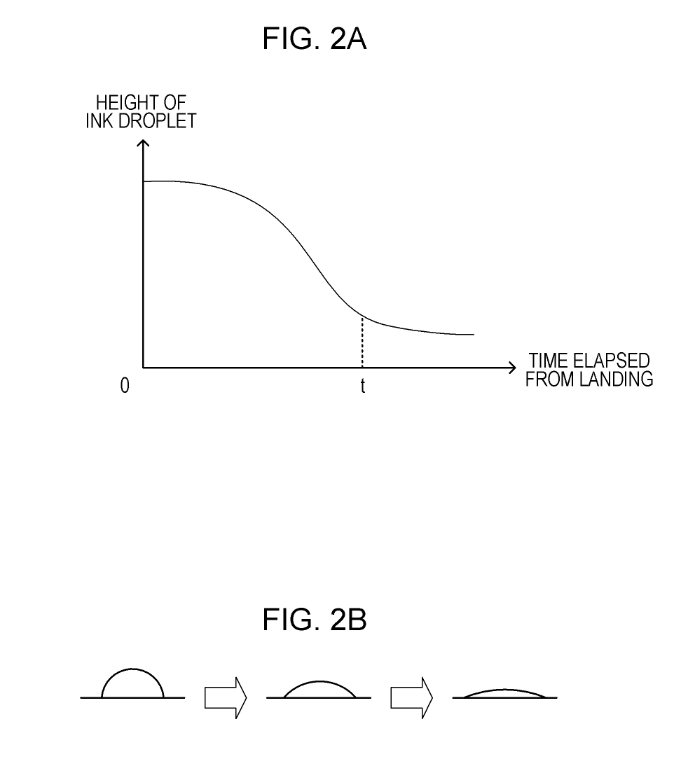

FIG. 2A shows a graph illustrating a relationship between a height and an elapsed time of the ink droplet after landing on the surface of the printing medium. FIG. 2B is a diagram schematically illustrating the change of shape viewed from the side of the ink droplet after landing on the surface of the printing medium. The height of the ink droplet represents the distance between the top of the ink droplet and the surface of the printing medium in the direction perpendicular to the surface of the printing medium. As shown in FIG. 2A and FIG. 2B, the height of the ink droplet gets lower as the time elapses after the ink droplet lands, and the diameter of the ink droplet viewed in the direction perpendicular to the surface of the printing medium gets larger. Accordingly, the surface area S of the ink droplet increases. As the surface area S gets larger, the ratio (Vn/V) of the volume Vn of the surface layer portion of the ink droplet affected by the influence of oxygen obstruction to the volume V of the whole ink droplet increases. Since the surface layer portion of the ink droplet described above is not hardened even when the ink droplet is irradiated with ultraviolet light, the ratio (Vn/V) of the volume Vn of the non-hardened portion to the volume V of the whole ink droplet gets higher as the time (pre-irradiation time) from landing to irradiating gets longer. A case where the ratio (Vn/V) is higher than a predetermined reference R ((Vn/V)>R) is called “unsatisfactory hardening”, and a case where the ratio (Vn/V) is equal to or lower than the reference R ((Vn/V)R) is called “satisfactory hardening”. The volume Vn of the surface layer portion of the ink droplet affected by the influence of oxygen obstruction is in the following relationship with respect to the surface area S.

Vn=S×p

In the relationship, p is a value corresponding to a thickness from the surface of the ink droplet, and is a constant (in the embodiment, p does not depend on time and is constant) which does not depend on the size of the ink droplet. Accordingly, the following relationship is obtained from Vn=S×p.

Ratio (Vn/V)=(S/V)×p

The ratio of the surface area to the volume gets lower as the volume gets larger. Accordingly, a relationship of small ink droplet (S_{S}/V_{S})>medium ink droplet (S_{M}/V_{M})>large ink droplet (S_{L}/V_{L}) is satisfied. Accordingly, the largeness and smallness relationship of the ratio (Vn/V) is small ink droplet ((S_{S}/V_{S})×p)>medium ink droplet ((S_{M}/V_{M})×p)>large ink droplet ((S_{L}/V_{L})×p). The surface area S uniformly increases with respect to time, the small ink droplet is fastest to be (S_{S}/V_{S})×p>R, and the large ink droplet is latest to be (S_{L}/V_{L})×p>R. Accordingly, the small ink droplet is faster than the medium ink droplet or the large ink droplet, and it is preferable to irradiate ultraviolet light.

When the time t until the ratio (Vn/V) is the reference R after the small ink droplet lands on the printing medium is a threshold value, it is possible to prevent the unsatisfactory hardening of the small ink droplet from occurring by irradiation of ultraviolet light for a time shorter than that. In the medium ink droplet and the large ink droplet, the time until the ratio (Vn/V) after landing becomes the reference R is longer than the time t in the small ink droplet. Accordingly, in the medium ink droplet and the large ink droplet, the pre-irradiation time may be longer than the time t (however, it is necessary to irradiate each of the large and medium ink droplets with ultraviolet light for a shorter time than the time until the ratio (Vn/V) becomes the reference R. In the embodiment, the pre-irradiation time of the ink droplets ejected from the nozzles farthest from the lighting unit is shorter than the time until the ratio (Vn/V) becomes the reference R in each of the large and medium ink droplets). In addition, the time from the ejection of the ink droplets to the landing on the printing medium is constant without depending on the size of the ink droplets. When the transport velocity of the printing head 24 in the main scanning direction is constant, the distance between the nozzle ejecting the ink droplet that is a target and the lighting unit is in a relationship proportional to the pre-irradiation time of the ink droplet. That is, it can be said that the pre-irradiation time of the ink droplets ejected from the nozzles lengthens as the distance to the lighting unit increases. Accordingly, when the transport velocity is v and the small ink droplets are ejected from the nozzles in which the distance from the lighting unit is longer than a distance vt, the pre-irradiation time of the small ink droplets becomes longer than the time t. Therefore, in that case, the small ink droplets are unsatisfactorily hardened.

### (3) PRINTING CONTROL PROCESS

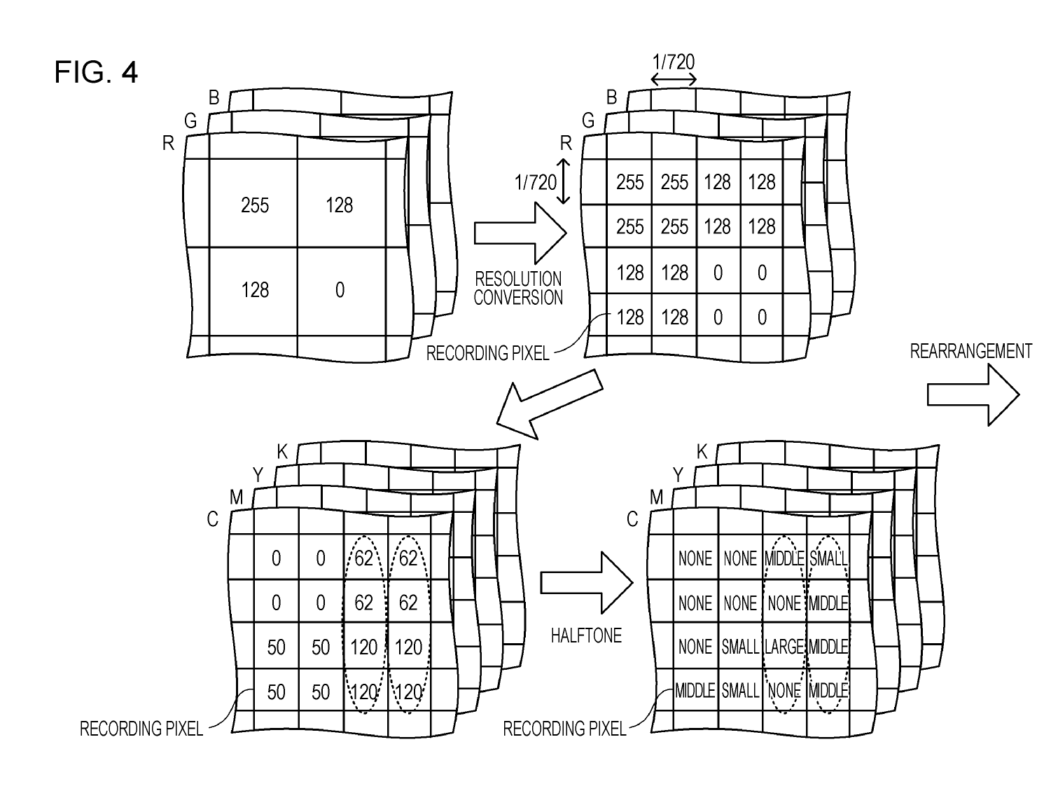

FIG. 4 is a diagram schematically illustrating an image process performed in the printing control process by the controller 10. When the controller 10 receives image data of a printing target, the controller 10 sequentially performs a resolution conversion process, a color conversion process, a halftone process, and a rearrangement process on the image data, to generate various control signals for controlling the carriage unit 20, the transport unit 30, the main hardening lamp unit 40, and the like. In the resolution conversion process, the controller 10 converts the resolution of the image data to coincide with the printing resolution. Accordingly, pixels constituting the image data are converted into recording pixels representing physical areas on the recording medium. In the example shown in FIG. 4, the image data in which RGB gradations (256 gradation) in an sRGB color space correspond to the pixels is input, the resolution of the image data is converted, and the pixels are converted into the recording pixels partitioned by 720×720 dpi on the recording medium. In the color conversion process, the controller 10 specifies the ink amount gradation (256 gradations) corresponding to the RGB gradation indicated by the recording pixels of the image data. For example, the color conversion process is performed with reference to a color conversion table regulating a correspondence relationship between the RGB gradation and the ink amount gradation of CMYK.

In the halftone process, the controller 10 specifies kinds of dots formed corresponding to the recording pixels on the basis of the ink amount gradation for the recording pixels. That is, in the pixels, it is specified whether to eject some ink droplets for forming a large dot (large), a medium dot (medium), and a small dot (small) or to form no dot (none).

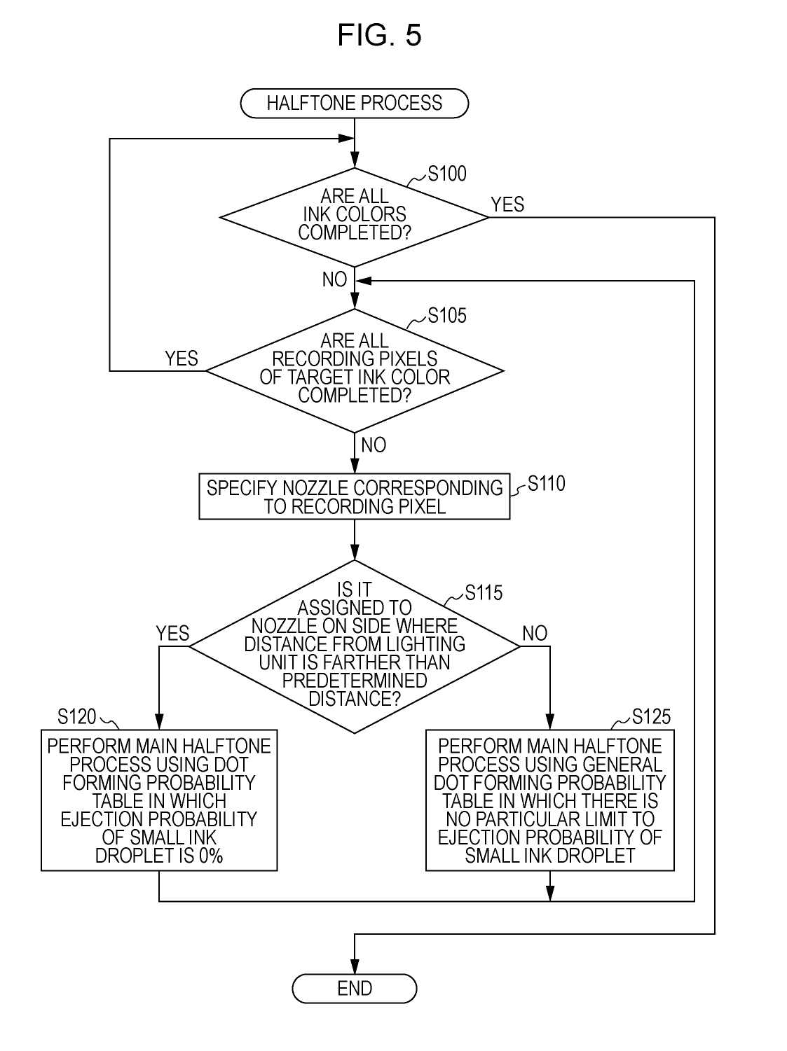

FIG. 5 is a flowchart illustrating a flow of the halftone process in the embodiment. The controller 10 determines whether or not the processes of Step S105 and later are completed for all ink colors (Step S100), and the processes of Step S105 and later are repeatedly performed until the processes are completed. The controller 10 determines whether or not the processes of Step S110 and later are completed for all recording pixel (Step S105), and the processes of Step S110 and later are repeatedly performed one by one on each recording pixel until the processes are completed. First, the controller 10 specifies nozzle ejecting ink droplets for forming a dot on the recording pixel (target recording pixel) that is a target (Step S110). Since the correspondence relationship between the recording pixel and the nozzle is determined according to the printing conditions such as resolution, Bi-D/Uni-D, and the number of passes, the nozzle corresponding to the target recording pixel is specified herein with reference to the correspondence relationship. When the printing is performed (Bi-D printing) at the time of operating both of forward movement and backward movement of the printing head 24, it is also specified to eject ink droplets at the time of any operation of forward movement and backward movement in the target recording pixel. Specifying the nozzle means that the nozzle row to which the nozzle belongs and the head area to which the nozzle row belongs are also specified. When the printing is performed only at the time of operating the forward movement of the printing head 24 (Uni-D printing), it is specified to eject the ink droplets at the time of operating the forward movement of the target recording pixel.

Subsequently, the controller 10 determines whether or not the target recording pixel can be assigned to the nozzle in which the distance from the lighting unit is larger than a predetermined distance (Step S115). When the distance between the nozzle specified in Step S110 and the lighting unit is larger than the predetermined distance, the controller 10 performs a main halftone process using a dot forming probability table in which ejection probability (the same meaning as the small dot forming probability) of small ink droplets in the nozzle is 0% (Step S120). The dot forming probability table is a table regulating the correspondence relationship between the ink amount gradation and the dot forming probability (probability of forming a large dot, probability of forming a medium dot, probability of a small dot, and probability of forming no dot). The main halftone process means a process of conversion from the ink amount gradation value into information representing a formed dot of a large dot, a medium dot, and a small dot, or no formed dot. When the distance between the nozzle and the lighting unit is smaller than the threshold value, the controller 10 performs the main halftone process using a general dot forming probability table provided with no particular limit to the ejection probability of the small ink droplets (Step S125). The controller 10 stores such a dot forming probability table in advance.

Hereinafter, a specific example of the processes from S115 to S120 or S125 will be described. FIG. 3A shows an example of a threshold value used in Step S115. The example shown in FIG. 3A shows an example in the head area H1 at the time of forward movement, and a distance from the position between two center K nozzles of 8 nozzle rows to the preliminary hardening LED 24b2 as the lighting unit at the time of forward movement is a predetermined distance th1. The predetermined distance th1 is set according to the time t and the transport velocity v of the printing head 24 described above. Specifically, the predetermined distance th1 is set to, for example, th1=vt. In addition, it may be considered that the time t is constant if the condition about the ease of spreading of ink droplets is the same. Accordingly, for example, in the case of transport velocity higher than the transport velocity v in the case shown in FIG. 3A, the predetermined distance is set to a value larger than th1. When the transport velocity is lower than the transport velocity v, the predetermined distance is set to a value smaller than th1. For example, the controller 10 sets the transport velocity on the basis of the printing condition set through the UI unit 50 by the user.

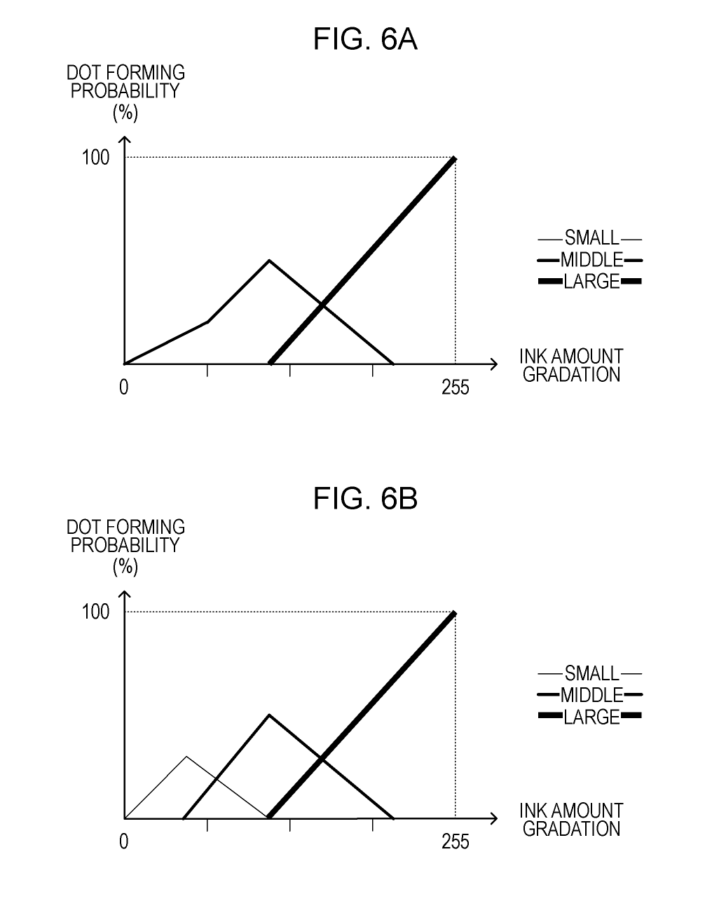

In Step S120, the controller 10 performs the main halftone process using the dot forming probability table in which the ejection probability of small ink droplets is 0%. FIG. 6A is a graph illustrating an example of a relationship between the ink amount gradation and the forming probability of each dot, which is regulated in the dot forming probability table in which the ejection probability of small ink droplets is 0%. In the ink amount gradation of 0, each of the probability of forming a large dot, the probability of forming a medium dot, and the probability of forming a small dot corresponds to 0%, and the probability of forming no dot corresponds to 100%. Accordingly, as for the recording pixel corresponding to 0 as the ink amount gradation, it is possible to obtain a result of the main halftone process of forming no dot. In the ink amount gradation of 255, the probability of forming a large dot corresponds to 100%, and each of the probability of forming a medium dot, the probability of forming a small dot, and the probability of forming no dot corresponds to 0%. Accordingly, as for the recording pixel corresponding to 255 as the ink amount gradation, it is possible to obtain a result of the main halftone process of forming a large dot. In the graph shown in FIG. 6A, even when the ink amount gradation is any value of 0 to 255, the probability of forming a small dot is 0%. For this reason, when the main halftone process is performed using the dot forming probability table regulating the relationship shown in FIG. 6A, the result of forming a small dot for the target recording pixel is not derived. In addition, the main halftone process is performed by the dither method, the error diffusion method, or the like, and the halftone process is performed on the basis of the dot forming probability regulated in the dot forming probability table by the adjustment of the gradation value in the dither method, the error diffusion method, or the like, or the threshold value for threshold value determination of the gradation value. For example, in the dither method, the error diffusion method, or the like, the gradation value regarding a small dot is set according to the dot forming probability, and the small dot is formed when the gradation value is larger than the threshold value. In this case, it is possible to lower the probability of forming a small dot by decreasing the gradation value for the small dot or increasing the threshold value for the small dot.

In Step S125, the controller 10 performs the main halftone process using the general dot forming probability table in which the ejection probability of small ink droplets is not particularly limited. FIG. 6B is a graph illustrating an example of the relationship between the ink amount gradation and each dot forming probability, regulated in the general dot forming probability table. In the example shown in FIG. 6B, the probability of forming a small dot is not 0% in case of a range in which the ink amount gradation is small. Accordingly, when the main halftone process is performed using the dot forming probability table regulating the relationship shown in FIG. 6B, it is possible to obtain a result of forming a small dot for the target recording pixel. Of course, result is obtained where several large and medium dots are formed and no dot is formed.

The result of the main halftone process will be described with reference to FIG. 4. In the example shown in FIG. 4, 4×4 ink amount gradation values are shown for C ink, as an example of the ink amount gradation after color conversion. In Step S110, for example, it is assumed that the recording pixels belonging to the rightmost row (50, 50, 105, and 105 from the upside) are determined to eject ink droplets from the nozzle 24ac1 (see FIG. 3A) belonging to the C nozzle row close to the preliminary hardening LED 24b2 of the head area H1 at the time of forward movement in the Bi-D printing, and the recording pixels belonging to the second row (50, 50, 105, and 105 from the upside) from the right side are determined to eject ink droplets from the nozzle 24ac2 (see FIG. 3A) belonging to the C nozzle row far away from the preliminary hardening LED 24b2 of the head area H1 at the time of forward movement in the Bi-D printing. In the example shown in FIG. 3A, since the distance Lc1 between the nozzle 24ac1 and the preliminary hardening LED 24b2 is smaller than the predetermined distance th1, the main halftone process described in Step S125 is performed on the first recording pixel from the right side. In the example shown in FIG. 3A, since the distance Lc2 between the nozzle 24a c2 and the preliminary hardening LED 24a2 is larger than the predetermined distance th1, the main halftone process described in Step S120 is performed on the second recording pixel from the right side. Even when the ink amount gradation value is the same value of 62, the case of the first recording pixel from the right side becomes any of (small), (medium), and (none), but the case of the second recording pixel from the right side becomes (medium) and (none) (does not become (small)).

The halftone process shown in FIG. 5 has been described above.

When the halftone process is ended, the controller 10 performs the rearrangement process (see FIG. 4). In the rearrangement process, the controller 10 rearranges the recording pixels of the image data in order of ejection timing in each main scanning pass of ejecting ink droplets by the nozzles 24a. As described above, the control signal for controlling the piezoelectric driver 25 is generated. The piezoelectric driver 25 can apply a driving voltage pulse to the piezoelectric element of the nozzle 24a corresponding to each recording pixel. In the embodiment, CMYK ink droplets are ejected respectively, but when the kind of formed dots is the same, the generated driving voltage pulse is common among CMYK inks.

When the image process shown in FIG. 4 is ended, the printing head 24 moves forward and backward to eject ink droplets from the nozzles by the piezoelectric driver 25 according to the ejection timing, on the basis of the control signal of the controller 10. As a result, it is possible to form an image on the printing medium. According to the embodiment, the nozzles in which the distance from the lighting unit is larger than the predetermine distance th1 are controlled so as not to eject the small ink droplets. That is, since it is possible to irradiate the small ink droplets with the ultraviolet light before the pre-irradiation time of the small ink droplets becomes longer than the time t, it is possible to prevent the unsatisfactory hardening of the small ink droplets from occurring.

### (4) MODIFIED EXAMPLE

The technical scope of the invention is not limited to the embodiment described above, and may be variously modified within the scope of the invention without deviating the concept of the invention. For example, in the embodiment, the threshold value corresponding to the time t in FIG. 2A is provided, and it is determined whether or not to eject the small ink droplets on the basis of the threshold value. However, for example, in the nozzles ejecting the ink droplets in which the pre-irradiation time is the second pre-irradiation time longer than the first pre-irradiation time, the ejection probability of the small ink droplets may be lower than that of the nozzles ejecting the ink droplets in which the pre-irradiation time is the first pre-irradiation time. That is, the longer the irradiation time of the nozzle, which is assignable to the pixel, the more the probability of forming a small dot may be stepwise decreased. As a result, it is possible to prevent the unsatisfactory hardening in the small ink droplets from easily occurring, as compared with the configuration of ejecting the small ink droplets at the same probability in the plurality of nozzles with the different lengths of the pre-irradiation time. In addition, for example, the longer the distance of the nozzle from the lighting unit, which is assignable to the pixel, the more the probability of forming a small dot may be stepwise decreased. As a result, it is possible to prevent the unsatisfactory hardening in the small ink droplets from easily occurring, as compared with the configuration of ejecting the small ink droplets at the same probability in the plurality of nozzles at the different distances from the lighting unit.

The threshold value for discriminating the nozzles which do not eject the small ink droplets and the other nozzles may be set according to the ease of spreading of ink droplets on the surface of the printing medium. Specifically, when using the second printing medium on which the ink droplets after landing spread more easily than the first printing medium, the threshold value is set to a value smaller than that of the case of using the first printing medium. When the set value of the threshold value can be changed according to the printing medium on which ink the ease of spreading of droplets is different, it is possible to prevent the unsatisfactory hardening of ink droplets from occurring in various printing mediums. The information representing the correspondence relationship between the kind of printing mediums and the ease of spreading of ink droplets is stored in advance, for example, in the controller 10. The controller 10 may specify the ease of spreading of ink droplets corresponding to the kind of the printing medium according to the ink of the printing medium selected by the user through the UI unit 50, and may set the threshold value.

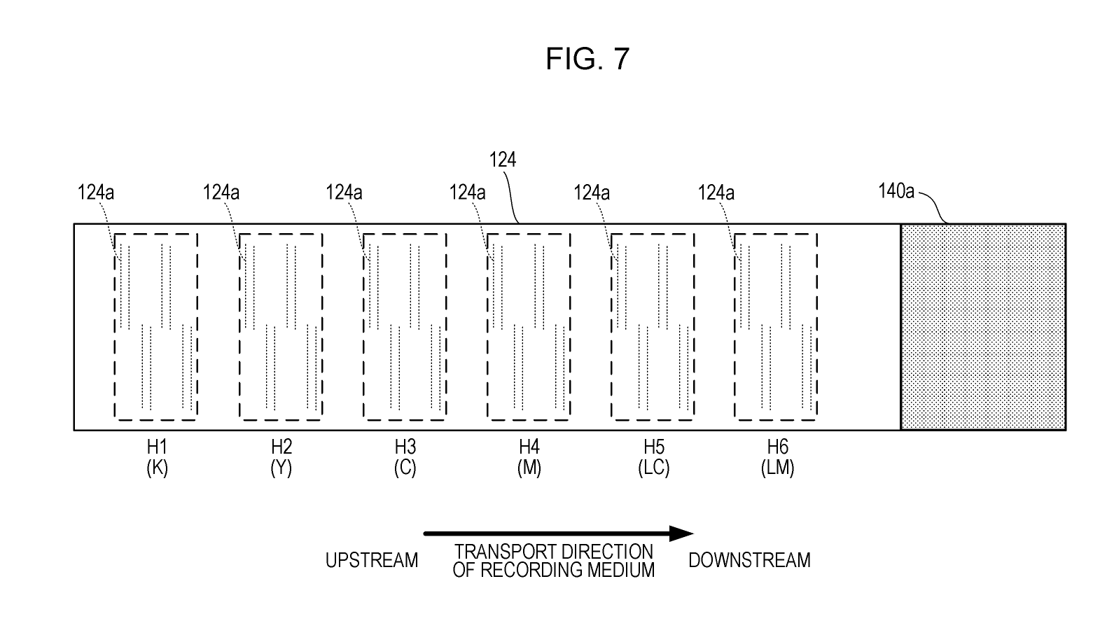

FIG. 7 is a diagram illustrating a printing head of a printing device according to the modified example. The printing device of the modified example is a line printer in which the printing head 124 does not move and only the recording medium is transported in a predetermined transport direction. The printing head 124 has a width wider than the width of the recording medium in a direction perpendicular to the transport direction, and is provided with a plurality of nozzle rows in which nozzles 124a are arranged in a linear shape in the width direction. The printing head 124 is provided with 6 head areas H1 to H6. The head area H1 is provided with the nozzles 124a ejecting ink droplets of K ink, the head area H2 is provided with the nozzles 124a ejecting ink droplets of Y ink, the head area H3 is provided with the nozzles 124a ejecting ink droplets of C ink, and the head area H4 is provided with the nozzles 124a ejecting ink droplets of M ink. The head area H5 is provided with the nozzles 124a ejecting ink droplets of LC (light cyan) ink, and the head area H6 is provided with the nozzles 124a ejecting ink droplets of LM (light magenta) ink. A main hardening lamp 140a is provided at the most downstream end in the transport direction of the recording medium in the printing head 124. Even in such a line printer, in the same manner as the embodiment, the ejection probability of small ink droplets is changed according to the pre-irradiation time or the distance from the lighting unit, and thus it is possible to prevent the unsatisfactory hardening from easily occurring. In addition, when the invention is applied to the line printer shown in FIG. 7, the main hardening lamp 140a corresponds to the lighting unit, and the printing medium transport unit transporting the printing medium corresponds to the transport unit.

In the disposition order of the head areas corresponding to the ink colors shown in FIG. 7, there is the following effect. The LC ink or the LM ink has an ink color fainter than the C ink or M ink. The LC and C are easily used when the LC expresses a faint color. The LM and M are easily used when the LM expresses a faint color. It is preferable that the image with the faint color is formed with small dots as possible, to reduce a granularity feeling. Accordingly, the LC or LM is easily ejected with small ink droplets. For this reason, in the case where the LC or LM are disposed at the position closer to the main hardening lamp 140a than the C or M as shown in FIG. 7, it is possible to shorten the pre-irradiation time of the small ink droplets ejected from the LC nozzles or LM nozzles, as compared with the case where the LC or LM is disposed at the position farther away from the main hardening lamp 140a than the C or M. The meaning that it is possible to shorten the pre-irradiation time is the same meaning as it is possible to prevent the unsatisfactory hardening from easily occurring, and means that it is possible to positively select ejecting the small ink droplets with respect to the LC ink or the LM ink. As a result, it is possible to reduce a granular feeling in the image with the faint color, and it is possible to prevent image quality from decreasing due to the unsatisfactory hardening of the ink droplets constituting the image with the faint color. Since the Y is a color which does not easily cause a granular feeling as compared with the C or M, the ejection probability of medium ink droplets may be higher than the probability of small ink droplets in the Y ink nozzles. For this reason, the Y may be disposed at the position farther away from the main hardening lamp 140a than the C or M.

In the embodiment, the configuration provided with the plurality of nozzle rows in which the distances from the lighting unit are different for each ink color is described, but the invention can be applied to a case where only one nozzle row is provided for each ink color. For example, in a printing head provided with one nozzle row for each color of CMYK, the K ink nozzles do not eject small ink droplets since the nozzles are farther away from the lighting unit than the threshold value. Even in that case, it is possible to express an image with a desired color by replacing small dots with medium dots or large dots while maintaining the ink amount gradation.

What is claimed is:

1. A printing device comprising:
a lighting unit that irradiates ink droplets landing on a surface of a printing medium with activated light rays to harden the ink droplets;
a transport unit that transports at least one of the printing medium and the lighting unit to move the ink droplets on the surface of the printing medium to an irradiation range of the activated light rays irradiated by the lighting unit; and
a plurality of nozzles that eject various kinds of ink droplets with different ink amounts, and are arranged such that distances of the nozzles from the lighting in a direction parallel to a transport direction of the transport unit are different from each other,
wherein in the nozzles ejecting the ink droplets in which a pre-irradiation time until the ink droplets move to the irradiation range after the ink droplets land on the printing medium is a second pre-irradiation time longer than a first pre-irradiation time, ejection probability of small ink droplets with the smallest amount of ink is lower than that of the nozzles ejecting the ink droplets in which the pre-irradiation time is the first pre-irradiation time.

2. The printing device according to claim 1, wherein the nozzles ejecting the ink droplets in which the pre-irradiation time is larger than a predetermined threshold value, do not eject the small ink droplets.

3. The printing device according to claim 2, wherein the nozzles in which a distance from the lighting unit in a direction parallel to the transport direction is longer than a predetermined distance are the nozzles ejecting the ink droplets in which the pre-irradiation time is larger than the threshold value, and
wherein the predetermined distance is set longer the higher the transport velocity in the transport unit.

4. The printing device according to claim 2, wherein when using a second printing medium on which the ink droplets after landing spread more easily than the first printing medium, the threshold value is smaller than that of the case of using the first printing medium.

5. The printing device according to claim 1, wherein the nozzles ejecting the ink droplets with an ink color in which the more easily the small ink droplets are ejected, the closer the nozzles are disposed to the lighting unit.
